(19) United States
(12) Patent Application Publication
(10) Pub. No.: US 2009/0217988 A1
(43) Pub. Date: Sep. 3, 2009

(54) DUAL SEAL VALVE

(75) Inventor: Stuart Maxwell, East Ryde (AU)

Correspondence Address: K&L Gates LLP, P.O. Box 1135, CHICAGO, IL, 60690, US

(73) Assignee: GLOBAL VALVE TECHNOLOGY LIMITED, Manly (AU)

(21) Appl. No.: 12/281,247

(22) PCT Filed: Mar. 2, 2007
(86) PCT No.: PCT/AU2007/000263

§ 371 Date: Mar. 27, 2009

Related U.S. Application Data
(60) Provisional application No. 60/812,117, filed on Jun. 9, 2006.
(60) Provisional application No. 60/816,885, filed on Jun. 28, 2006.

(30) Foreign Application Priority Data
Mar. 2, 2006 (AU) 2006901049

(51) Int. Cl. F16K 15/00

(52) U.S. Cl. 137/511

(57) ABSTRACT

A valve (10) is disclosed comprising a valve housing (14) including a valve seat (12), a valve head (16) movably housed within the valve housing (14) for seating with the valve seat (12), and a lip seal (30) connected to either the valve head (16) or the valve seat (12). The lip seal (30) is configured to be hydraulically biased into contact with the valve seat (12) or the valve head (16) to maintain closure of the valve.

### FIELD OF THE INVENTION

The present invention relates broadly to a valve and relates particularly, although not exclusively, to a non-return valve, check valve or back flow prevention device or valve.

### BACKGROUND OF THE INVENTION

Back flow valves, non-return valves and check valves are used throughout plumbing systems. Check valves of a duckbill configuration are relatively well known and used in the art of valves. The patent literature has a large number of patents disclosing duckbill valves including U.S. Pat. Nos. 3,901,272, 4,524,805, 3,822,720, 4,240,630 and 6,089,260. These patents similarly disclose a valve of a duckbill form having a slit at its outlet. The slit is designed to elastically deform and open when tension is applied about is periphery whereas closure of the slit is automatically provided by biasing stresses in the valve as a consequence of its shape.

The prior art of U.S. Pat. No. 996,588 and German patent no. 4,033,818 describe variants of the duckbill check valves of the preceding art. Both U.S. Pat. No. 996,588 and DE 4,033,818 are valves of a generally conical shape designed to permit flow in a single direction only. U.S. Pat. No. 996,588 is a check valve with a transverse slit through a relatively thick apex portion of the valve which is tensioned under fluid pressure to elastically deform and open. DE 4,033,818 is a pressure relief valve having a discharge aperture at its apex which opens and releases pressure at a predetermined pressure. The valve of DE 4,033,818 is constructed of a highly elastic synthetic resin or rubber which is biased closed but under pressure is stressed about the discharge aperture which is opened.

The applicants (or their predecessors) of international patent application no. PCT/AU00/00659 disclose a non-return valve having a valve diaphragm of a conical-shape. The valve diaphragm which is constructed of a resiliently flexible material includes a collapsible aperture which is exposed so as to open under fluid pressure on an upstream side of the valve. The valve diaphragm is tensioned or stressed about the collapsible aperture and the wall thickness of the diaphragm is reduced toward its apex to facilitate this opening of the valve.

These check or non-return valves suffer from at least the following problems:
(i) the differential pressure required across the valve to effect its opening is relatively high;
(ii) the valve may be designed to reduce this differential pressure for opening but then has a tendency to leak (reverse flow) at relatively low differential pressures; and
(iii) the valve in its open condition does not provide great flow throughputs as the throat restriction of the slit or collapsible opening is relatively high.

### SUMMARY OF THE INVENTION

According to one aspect of the invention there is provided a valve comprising:

a valve housing including a valve seat;

a valve head movably housed within the valve housing for seating with the valve seat; and

a lip seal connected to either the valve head or the valve seat and being configured to be hydraulically biased into contact with the valve seat or the valve head to maintain closure of the valve.

Preferably the lip seal is hydraulically biased into contact with the valve seat or the valve head to maintain closure of the valve at relatively low differential pressures across the valve head.

According to another aspect of the invention, there is provided a valve comprising:

a valve housing including a valve seat;

a valve head movably housed within the valve housing for seating with the valve seat; and

a pair of seals each being connected to either the valve head or the valve seat, one of the pair of seals being a supplementary seal biased at least in part by fluid pressure on its underside to maintain closure of the valve on at least partial unseating of the other of the pair of seals from the valve seat or the valve head.

Preferably the supplementary seal is additionally biased at least in part by a resiliently deformable seal portion. Preferably the supplementary seal is in the form of a lip.

Preferably the lip seal is inclined at an acute angle to an attaching surface defining a pressure cavity. More preferably the cavity is defined by an underside of the lip seal. Even still more preferably the lip seal is attached to the valve head.

Preferably the other of the pair of seals is a compression seal. More preferably the compression seal is a half O-ring type seal.

Preferably the lip seal and the compression seal are both formed integral with the valve head. More preferably the lip seal protrudes beyond the compression seal for contact with the valve seat prior to seating of the compression seal on closure of the valve.

Preferably the valve head includes a stop to prevent over-compression of the supplementary seal. More preferably the stop is the other seal.

Preferably the valve also comprises a valve opening formed about an inner surface of the valve seat. More preferably the valve opening is in the form of an orifice and the supplementary seal or the lip seal is located adjacent the orifice when the valve is closed. More preferably the lip seal is inclined towards the orifice when the valve is closed. Still more preferably the other seal is located radially outside the supplementary seal.

Generally the valve is a non-return valve.

### BRIEF DESCRIPTION OF THE FIGURES

In order to achieve a better understanding of the nature of the present invention a preferred embodiment of a valve will now be described in some detail, by way of example only, with reference to the accompanying drawings in which:

FIG. 1 is a cross-sectional view of one embodiment of a valve according to the invention, the valve being closed;

FIG. 2 is a cross-sectional view of the same embodiment of the valve according to the invention, the valve being opened;

FIG. 3 is a cross-sectional view taken through AA of FIG. 2;

FIG. 4 is a cross-sectional view taken through BB of FIG. 2; and

FIGS. 5-12 illustrate finite element analysis data showing opening of a valve in another embodiment of the invention.

### DETAILED DESCRIPTION OF THE PREFERRED EMBODIMENT

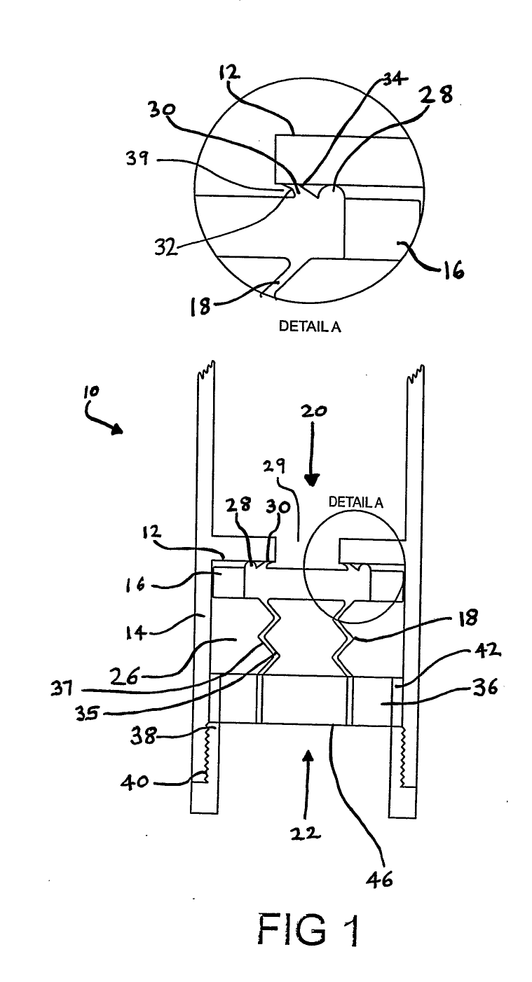

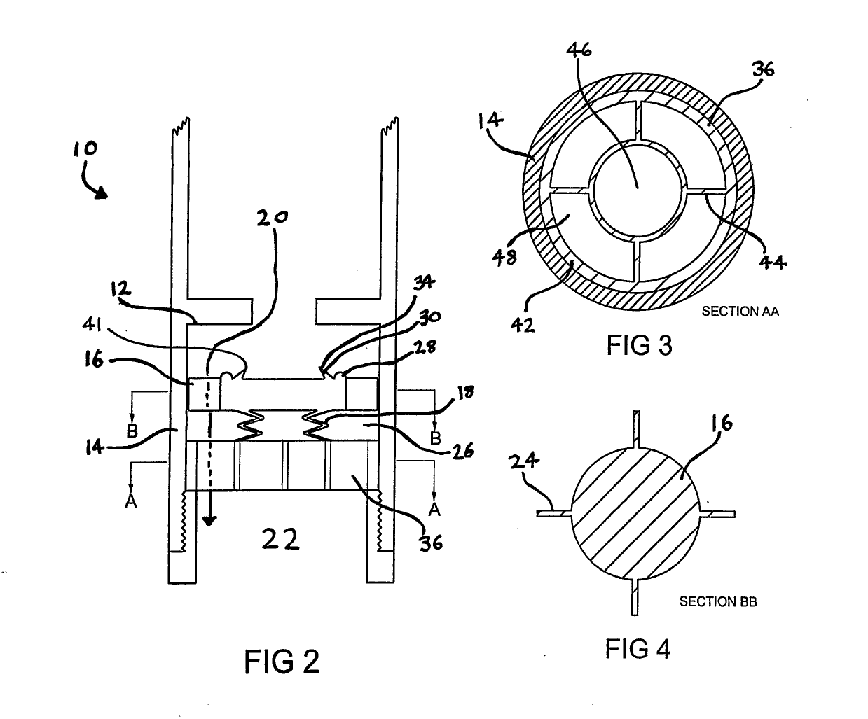

FIGS. 1 and 2 depict one embodiment of a valve generally depicted as 10 according to the invention. The valve in this example is a water valve of a non-return type 10 comprising a valve housing 14 including a valve seat 12. In this embodiment, the valve seat is defined by an inwardly directly annular flange 12. The valve assembly 10 also comprises a valve head 16 which contacts the valve seat 12 for closure of the valve assembly 10. The valve assembly 10 further comprises biasing means in the form of an elongate bellows 18 connected to the valve head 16. As shown in FIG. 1, the bellows 18 is resiliently deformable and pre-stressed, or slightly compressed in its closed state within the valve housing 14, so that it urges the valve head 16 towards and into sealing contact with the valve seat 12.

The flow of fluid 20 in a forward direction through the open valve assembly 10 is shown in FIG. 2. Force or pressure from the fluid 20 applied to the valve head 16 from the direction of the valve seat 12 unseats the valve head 16 allowing the fluid 20 to pass through the valve assembly 10. The opening of the valve 10 is effected provided the force exerted by the fluid 20 is greater than the force exerted in an opposite direction by the bellows 18 combined and by fluid pressure in a reverse flow direction 22.

As shown in FIG. 1, the valve head includes a pair of integrally formed seals. One of the seals is a half O-ring type seal 28 for contact of the valve seat 12 on seating of the valve head 16. The sealing is enhanced as the force exerted by the reverse fluid flow 22 on valve head 16 increases. In another embodiment not shown here, the half O-ring type seal 28 comes to a point for contacting the valve seat 12, the point deforming under small loads to comply with a rough valve seat 12.

The valve head 16 also includes a supplementary seal in the form of a lip seal 30 formed of a resiliently deformable material. As shown in FIG. 2, the lip seal 30 is, in this embodiment, thin and flexible, and tapers to a knife-like edge 41. In this example, the manufacture of the knife-like edge is achieved by injection of a settable material into a two part mould. When the valve is open the lip seal 30 protrudes beyond the compression seal 28. The lip seal 30 is located adjacent a valve opening or orifice 29 formed about an inner surface of the valve seat 12 of the closed valve. The lip seal 30 is inclined at an acute angle of about 10-60 degrees to the valve head 16, defining a pressure cavity 39. The lip seal 30 is inclined towards the orifice 29 when the valve 10 is closed. At least part of the lip seal, and preferably all of it, defines a resiliently deformable seal portion 30 that at least in part biases the lip seal 30 towards the valve seat 12. The lip seal 30 has an underside 32, defining the pressure cavity 39 for receiving a portion of the fluid 20 on closure of the valve 10. The fluid urges the lip seal 30 into sealing contact with the valve seat 12, that is, the lip seal 30 is hydraulically biased into contact with the valve seat 12. The seal is formed by the contact of an outer surface 34 of the lip seal 30 with the valve seat 12.

For small forward pressures, the resilient lip seal 30 maintains closure of the valve as the valve head 16 moves away from the valve seat 12. Also, prestressing of the bellows 18 acts to push the valve head 16 in contact with the valve seat 12, to close the valve. The holding pressure of the valve is determined by the strength of these two mechanisms together. In the preferred embodiment the forward holding pressure is at least 0.5 kPa and preferably from 2 to 10 kPa. It will be appreciated that at least in the preferred embodiment, the configuration of the lip seal 30 is such that the hydraulic biasing maintains closure of the valve 10 when the forward flow fluid pressure 20 is slightly higher than the reverse flow fluid pressure 22. The cavity 39 in effect captures the fluid or water at low pressure and forces the lip seal 30 against the valve seat 12.

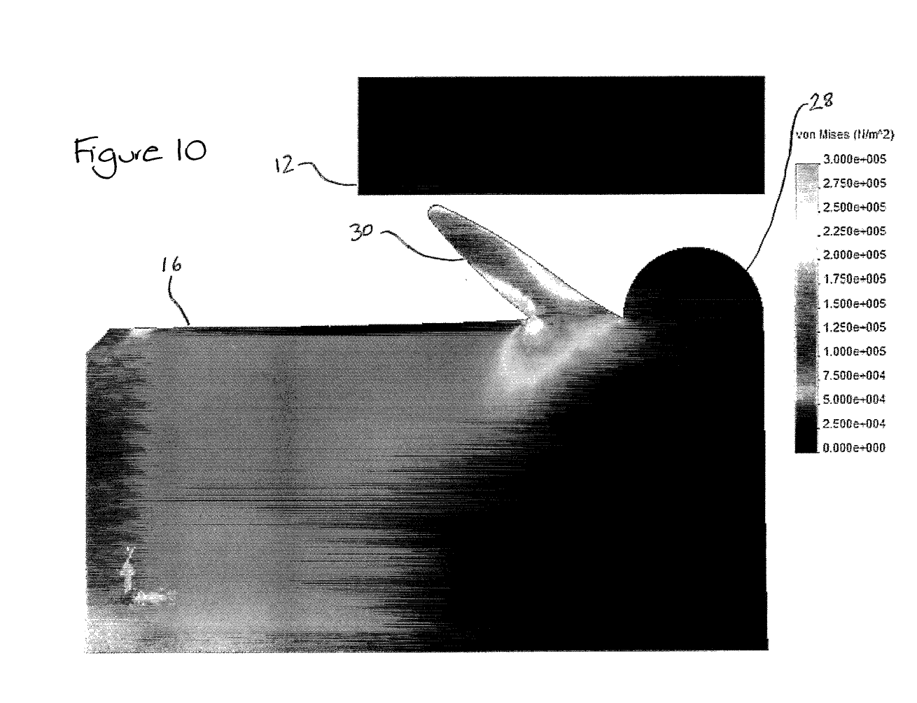

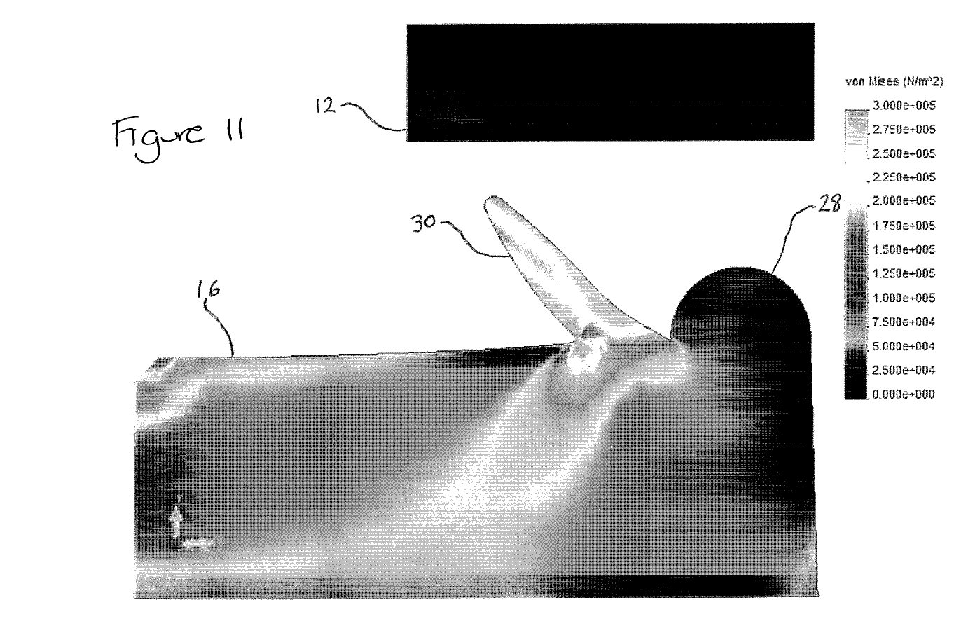

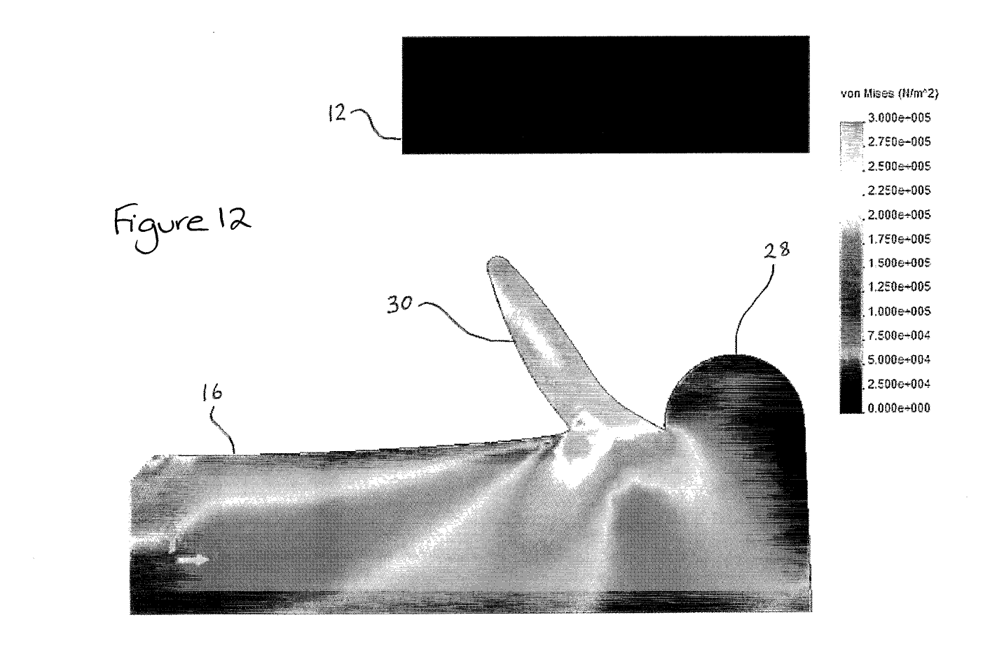

The seal formed by the contact of the lip seal outer surface 34 with the valve seat 12 is maintained on at least partial unseating of the O-ring type seal 28. FIGS. 5 to 12 illustrate the action of the lip seal 30 as another embodiment of the valve 10 opens. FIG. 5 shows the valve 10 under high back pressure. Both seals 28 and 30 contact the valve seat 12. FIG. 6 shows the closed valve 10 with decreased back pressures. FIG. 7 shows the valve with no pressure differential across the valve head 16. Here, only the pre-stressing of the bellows 18 is forcing closure of the valve 10. FIGS. 8 and 9 show the valve when the forward flow pressure is slightly greater that the reverse flow pressure, but the pressure differential is still less than the holding pressure of the valve 10, this typically being from 0.5 to 10 kPa. The lip seal 30 is still in sealing contact with the valve seat 12 even though the O-ring type seal 28 no longer contacts the seat 12. As the forward pressure increases, the angle that the lip seal 30 makes with the valve head 16 increases, and the lip seal 30 moves away from the valve head 16. FIGS. 10 to 12 show the valve opened by a forward pressure greater than the holding pressure of the valve 10. Neither seal 28 or 30 are in contact with the valve head 12.

As illustrated in FIG. 5, the O-ring type seal 28 also acts as a stop for limiting compression of the lip seal 30 at high fluid pressures, preventing damage of the lip seal 30. The O-ring type seal 28 is located radially outside the lip seal 34.

In some other embodiments not illustrated here, the O-ring type seal 28, the lip seal 30 or both of these seals are connected to the valve seat 12 instead of the valve head 16.

In this embodiment, the valve assembly 10 also comprises a support member 36 connected to the bellows 18 at an opposite end to the valve head 12. The support member 36 is shown in cross-section in FIG. 3. The support member 36 includes an inner central opening 46 for equalisation of fluid pressure inside and outside the bellows 18. This pressure equalisation reduces the likelihood of the bellows 18 being deformed or distorted by fluid pressure.

The support member 36 is mounted within the valve housing 14 by mounting means 38. In this embodiment the mounting means 38 is detachably connected by way of a screw thread 40 cut into both the valve housing 14 and the mounting means 38. The mounting of the support member 36 allows for the pre-stressing of the bellows 18. In this embodiment the support member 36 includes an outer ring member 42 housed coaxially within the valve housing 14 and a plurality of radial members in the form of radial ribs, such as 44 defining outer fluid openings, such as 48. The outer fluid openings 48 are a continuation of the fluid passageway 26 outside the bellows.

In one embodiment of the invention (not shown), the support member 36 has a screw thread on its outside circumference. This enables the support member 36 to be detachably connected to the threaded valve housing 14 without the use of separate mounting means such as 38. It will be appreciated that other methods of mounting the support member, such as a bayonet mount, or a press fit could also be used.

In another embodiment (not shown), the valve housing is a cartridge or cage. The cartridge or cage may be split longitudinally and hinged for insertion of the valve head 16, bellows 18 and support member 36. It will be understood that the cartridge makes installation of the water valve assembly simpler.

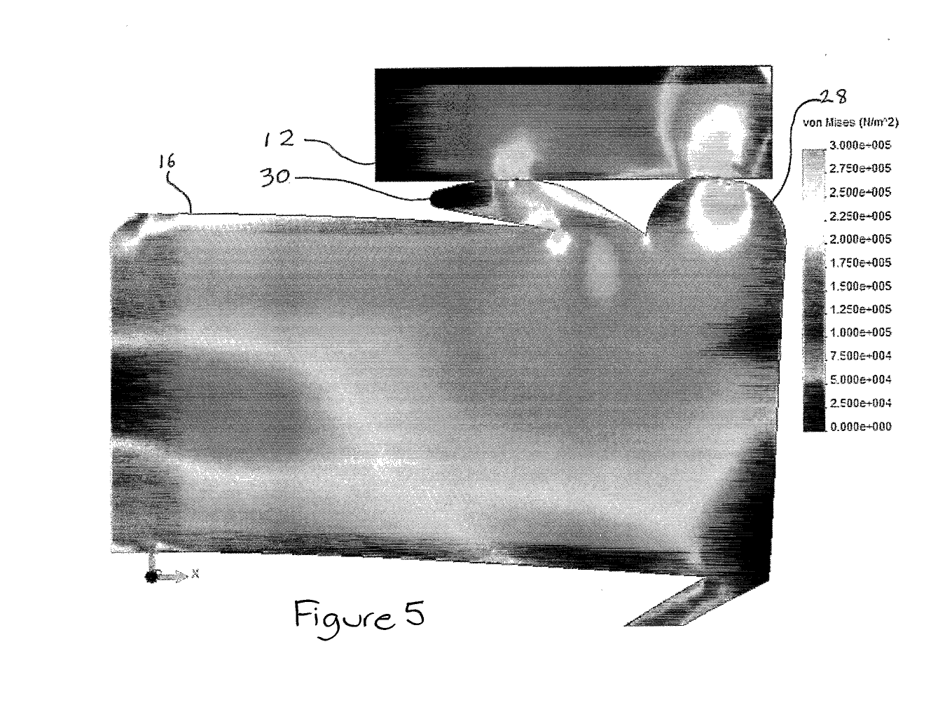

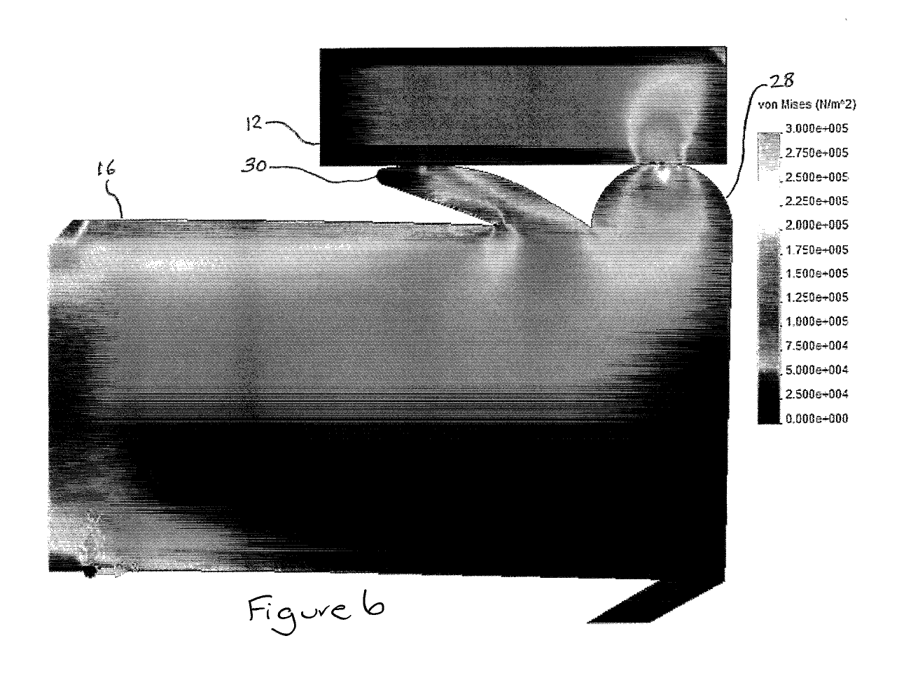

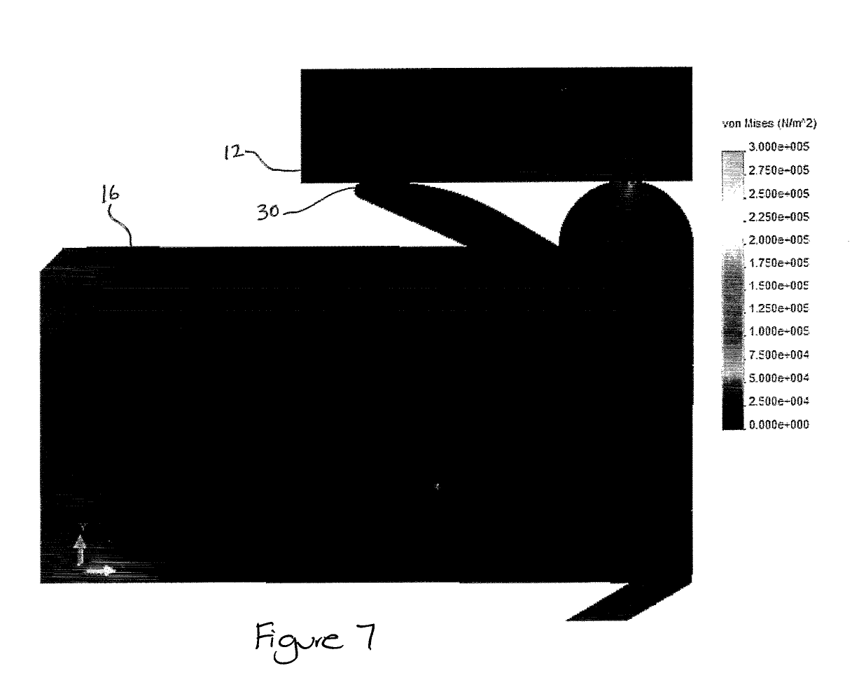

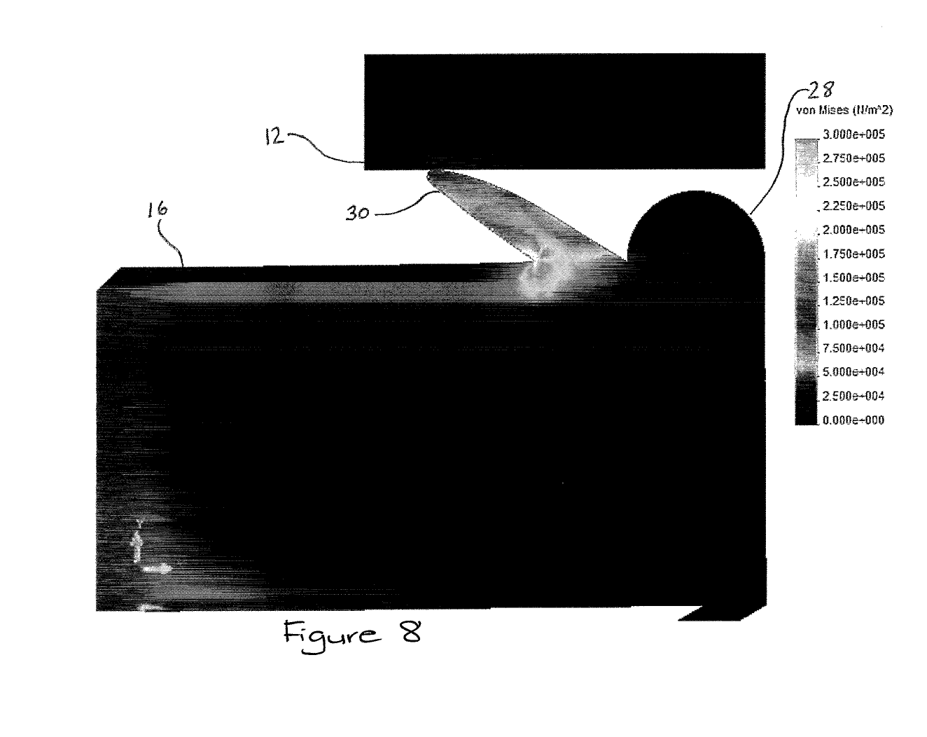

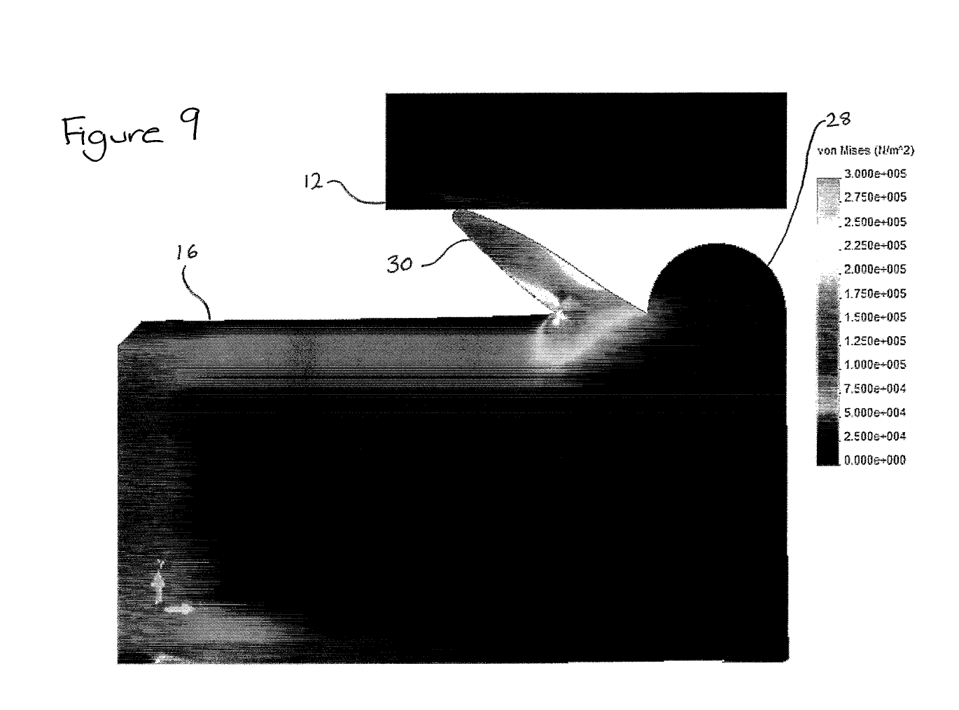

As shown in FIG. 4, the valve head 16 includes guiding means which in this embodiment are radial protrusions in the form of spokes 24 connected to and radiating outwardly from the valve head 16. The guiding means or spokes 24 ensure that the valve head 16 remains coaxially aligned with the valve housing 14 during sliding movement of the valve head 16 within the housing 14. The use of relatively thin spokes 24 reduces obstruction of a fluid passageway 26 that is formed between the resiliently deformable bellows 18 and the valve housing 14. The fluid 20 that flows through the valve assembly 10 flows through the fluid passageway 26 outside the bellows 18.

In the illustrated embodiment, the valve assembly is a cylindrical valve assembly 10 having the valve head 16 and bellows 18 housed coaxially within the valve housing 14. Furthermore, in this embodiment the valve head, bellows and base portion are of a unitary design.

Now that a preferred embodiment of the invention has been described, it will be apparent that it has the following advantages:
(i) the valve assembly has minimal leakage and remains closed at relatively low differential pressures;
(ii) the differential pressure required across the valve assembly to effect its opening is relatively low;
(iii) the valve assembly is highly resistant to reverse flow pressures; and
(iv) the valve assembly in its open condition allows relatively high flow throughputs.

It will be appreciated by persons skilled in the art that numerous variations and/or modifications may be made to the invention as shown in the specific embodiments without departing from the spirit or scope of the invention as broadly described. For example, the valve assembly may be of a square rather than cylindrical cross-section, and the valve head, bellows and support member may be separable rather than being of a unitary design. The sealing arrangement of the valve may vary from that described, for example:
(i) the valve may include a single lip seal only;
(ii) the valve may include a pair of lip seals (without the O-ring type seal) of the same or different configurations.

The present embodiments are, therefore, to be considered in all respects as illustrative and not restrictive.

It is to be understood that any acknowledgment of prior art in this specification is not to be taken as an admission but this acknowledged prior art forms part of the common general knowledge in Australia or elsewhere.

1. A valve comprising:
a valve housing including a valve seat;
a valve head moveably housed within the valve housing for seating with the valve seat;
a resiliently flexible seal connected to either the valve head or the valve seat; and
a lip seal formed integral with either the valve head or the valve seat and being positioned radially inward of the resiliently flexible seal, the lip seal being hydraulically biased at least in part by fluid pressure to maintain closure of the valve.

2. The valve as claimed in claim 1 wherein the lip seal is hydraulically biased into contact with the valve seat or the valve head to maintain closure of the valve at relatively low differential pressures across the valve head.

3. The valve as claimed in claim 1 wherein the lip seal is inclined at an acute angle to an attaching surface defining a pressure cavity.

4. The valve as claimed in claim 3 wherein the cavity is defined by an underside of the lip seal.

5. The valve as claimed in claim 1, wherein the lip seal is attached to the valve head.

6. The valve as claimed in claim 1, wherein the valve is a non-return valve.

7. The valve as claimed in claim 1, wherein the resiliently flexible seal is a compressed seal.

8. The valve as claimed in claim 7 wherein the compressed seal is a semi-circular O-ring type seal.

9. The valve as claimed in claim 7 wherein the lip seal and the compressed seal are both formed integral with the valve head.

10. The valve as claimed in claim 7 wherein the lip seal protrudes beyond the compressed seal for contact with the valve seat prior to seating of the compressed seal on closure of the valve.

11. The valve as claimed in claim 7 wherein the valve head includes a stop to prevent over-compression of the lip seal.

12. The valve as claimed in claim 11 wherein the stop is the compressed seal.

13. The valve as claimed in claim 7 also comprising a valve opening formed about an inner surface of the valve seat.

14. The valve as claimed in claim 13 wherein the valve opening is in the form of an orifice and the lip seal is located adjacent the orifice when the valve is closed.

15. The valve as claimed in claim 14 wherein the seal is inclined towards the orifice when the valve is closed.
